(19) United States
(12) Patent Application Publication
(10) Pub. No.: US 2017/0154599 A1
(43) Pub. Date: Jun. 1, 2017

(54) Source Driver Having Fan-Out Wire Compensation Design For Display Device

(71) Applicant: Raydium Semiconductor Corporation, Hsinchu (TW)

(72) Inventors: Chih-Chuan HUANG, Zhubei City (TW); Shun-Yuan WANG, Taoyuan City (TW)

(21) Appl. No.: 15/364,493

(22) Filed: Nov. 30, 2016

Related U.S. Application Data
(60) Provisional application No. 62/261,335, filed on Dec. 1, 2015.

(51) Int. Cl. G09G 3/36

(52) U.S. Cl. CPC G09G 3/3688; G09G 2300/08; G09G 2300/0408

(57) ABSTRACT

A display device of the present invention includes a display substrate and a source driver. The display substrate includes a display area and a peripheral area surrounding the display area. At least a fan-out portion is formed on the peripheral area and distributes along a first direction. The fan-out portion has a plurality of fan-out wires. The source driver is connected to one side of the fan-out portion opposite to the display area. The source driver includes a plurality of driving circuits. An output end of each driving circuit has a modulation unit coupled to one of the plurality of the fan-out wires. The fan-out portion has a resistance value distribution along the first direction. The resistance value of the modulation unit in each driving circuit is modulated according to the resistance value distribution.

### CROSS REFERENCE TO RELATED APPLICATIONS

The present disclosure claims priority to U.S. Provisional Patent Application No. 62/261,335, filed Dec. 1, 2015, which is incorporated herein by reference in its entirety.

### BACKGROUND OF THE INVENTION

1. Field of the Invention

The present invention relates to a source driver of a display device; particularly, the present invention relates to fan-out wires of the source driver and the display device.

2. Description of the Prior Art

The source driver is one of the important components in a display device. Wires (such as data lines) on a display substrate are connected to the source driver via the peripheral area of the display substrate. FIG. 1A and FIG. 1B are schematic views of a traditional display device. As shown in FIG. 1A, the display device 10 has source drivers 12. Each source driver 12 is connected to wires 18 via the peripheral area of the display substrate 11. As shown in FIG. 1A, each source driver 12 is connected to the wires 18 via connecting lines 14. Connecting lines 14 forms a fan-out portion 16 at the peripheral area of the display device 11. Because each wire 18 has a different position relative to the corresponding source driver 12, the distances between the source driver 12 and each of the wires are different. Therefore, connecting lines 14 have different resistance values.

In order to overcome the differences in resistance value mentioned above, the traditional technique provides a solution to modify connecting lines 14 in the fan-out portion 16 and utilize the modified fan-out portion 16 to compensate for the differences in resistance value. For example, as shown in FIG. 1A, the middle one of the connecting lines 14 is designed as a curved shape to reduce the differences in resistance value between the source driver 12 and each of the wires 18. In addition, as shown in FIG. 1B, another solution is to dispose connecting lines 14 with different widths based on the relative positions between the source driver 12 and each of wires 18. For example, in each of the fan-out portion, the connecting lines 14 located at the left and right side are wider than the connecting line 14 located at the middle position.

However, the aforementioned solutions will increase the size of the peripheral area in the display substrate and thus restrict the size of the display area. In addition, although the above solutions can reduce the differences in resistance value, in fact, resistance values of the connecting lines are still different, which leads to poor display quality. Besides, with the narrow-border design adopted in the display device, the size of the peripheral area is greatly reduced, making the traditional methods hard to use. As mentioned above, the compensation method utilized in the traditional display device needs to be improved.

### SUMMARY OF THE INVENTION

It is an object of the present invention to provide a source driver which can decrease a frame area of a display device.

The display device includes a display substrate and a source driver. The display substrate includes a display area and a peripheral area surrounding the display area. At least a fan-out portion is formed on the peripheral area and distributes along a first direction. The fan-out portion has a plurality of fan-out wires. The source driver is connected to one side of the fan-out portion opposite to the display area. The source driver includes a plurality of driving circuits. An output end of each driving circuit has a modulation unit coupled to one of the plurality of the fan-out wires. The fan-out portion has a resistance value distribution along the first direction. A resistance value of the modulation unit in each driving circuit is modulated according to the resistance value distribution.

### BRIEF DESCRIPTION OF THE DRAWINGS

FIG. 1A and FIG. 1B are schematic views of a traditional display device;

FIG. 2A is a schematic view of an embodiment of the display device of the present invention;

FIG. 2B is a schematic view of a source driver of the present invention;

FIG. 3 is a schematic view of a resistance value distribution of fan-out wires;

FIG. 4 is a schematic view of another embodiment of the display device of the present invention;

FIG. 5A and FIG. 5B are schematic views of the resistance value distribution of a fan-out wires.

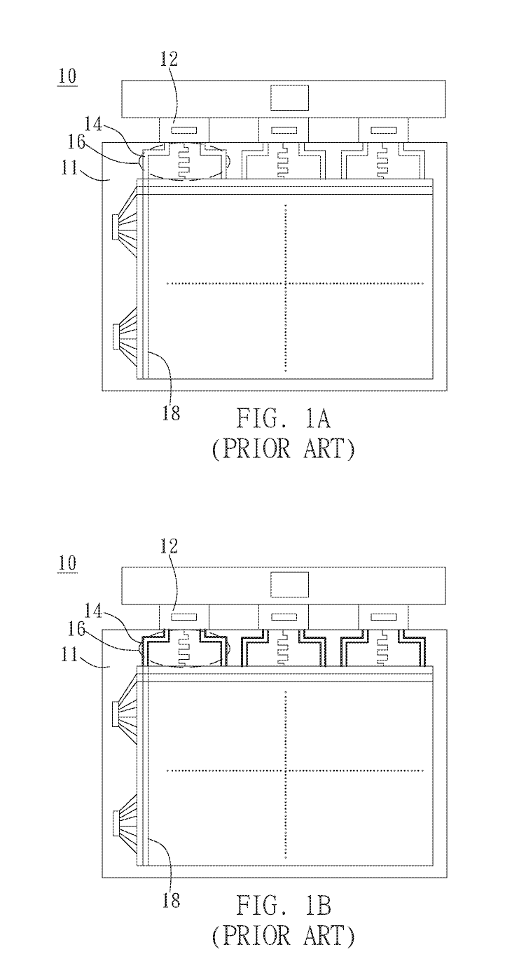

### DETAILED DESCRIPTION OF THE PREFERRED EMBODIMENT

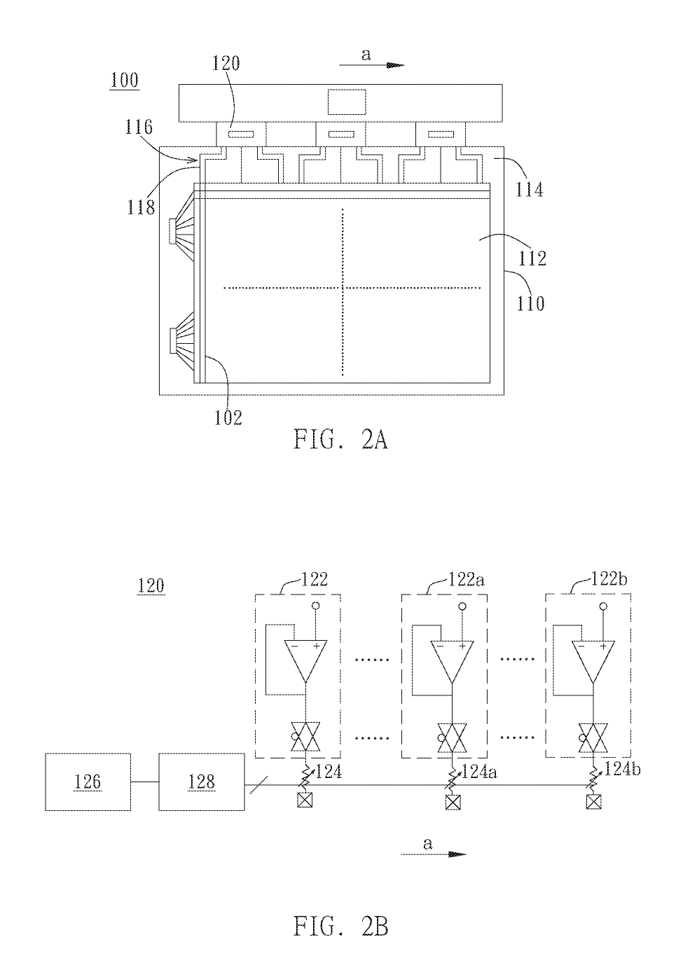

The present invention provides a source driver which can be used in a display device, such as a liquid crystal display device. FIG. 2A is a schematic view of an embodiment of the display device 100 of the present invention. As shown in FIG. 2A, the display device 100 includes a display substrate 110 and a plurality of source drivers 120. The display substrate 110 includes a display area 112 and a peripheral area 114 surrounding the display area 112. A plurality of fan-out portions 116 is formed on the peripheral area 114 along a first direction (a). Each fan-out portion 116 has a plurality of fan-out wires 118.

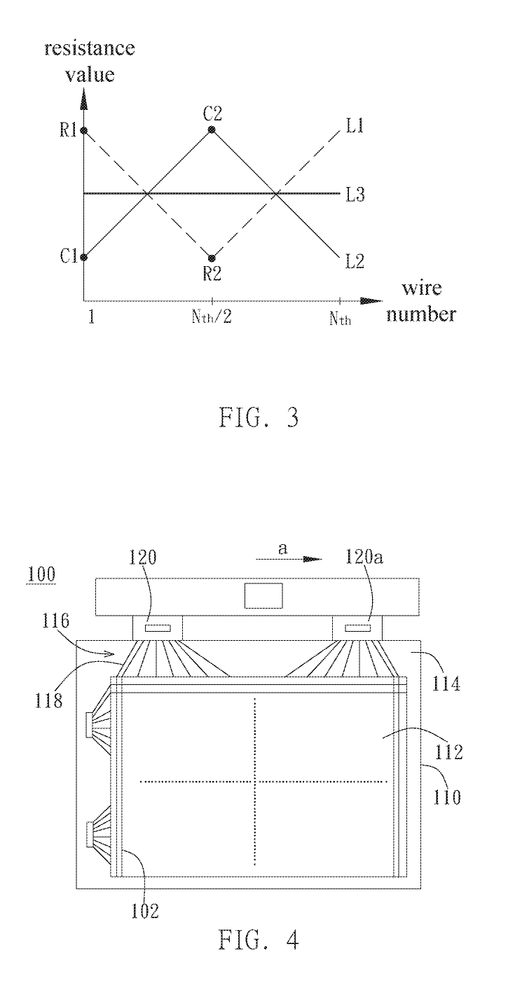

As shown in FIG. 2A, each source driver 120 corresponds to one fan-out portion 116, respectively. The source driver 120 is connected to one side of the fan-out portion 116 opposite to the display area 112. The display area 112 has a plurality of wires 102 (such as data lines). As shown in FIG. 2A, the source driver 120 is connected to the plurality of wires 102 located in the display area 112 via the plurality of fan-out wires 118. Each fan-out wire 118 has a different resistance value because the position of the source driver 120 relative to each fan-our portion 116 is different. In other words, each fan-out portion 116 has a resistance value distribution (please refer to FIG. 3) along the first direction (a).

FIG. 2B is a schematic view of the source driver 120 of the present invention. As shown in FIG. 2B, the source driver 120 includes a plurality of driving circuits (122, 122a, 122b). The driving circuit 122 outputs a driving signal generated from the source driver 120 to the display substrate via the fan-out portion mentioned above. Please refer to FIG. 2A and FIG. 2B, the driving circuit 122 is coupled to the plurality of fan-out wires 118 of the fan-out portion 116. For example, the plurality of driving circuits (122, 122a, 122b) distributes along the first direction (a), and each fan-out wire 118 distributes along the first direction (a) and is connected to one of the plurality of driving circuits (122, 122a, 122b) based on the order of arrangement. The driving signal mentioned above is preferred an analog signal, or can be a digital signal based on product requirement.

The source driver 120 further includes a plurality of modulation units (124, 124a, 124b). As shown in FIG. 2B, an output end of each driving circuit has one modulation unit. Taking the driving circuit 122 as an example, the driving circuit 122 is coupled to the fan-out circuit 118 via the modulation unit 124. In an embodiment, the modulation unit 124 may be an adjustable resistor. In other embodiments, the modulation unit 124 may be a metal oxide semiconductor or a diode. The resistance value of the modulation unit 124 in each driving circuit is modulated according to the resistance value distribution.

In addition, the source driver 120 further includes a control circuit 126. As shown in FIG. 2B, the control circuit 126 is connected to the plurality of driving circuits (122, 122a, 122b) via a voltage level shifting circuit 128. The control circuit 126 can activate a compensation mode to modulate the resistance value of the modulation unit in each driving circuit according to the resistance value distribution.

Please refer to FIG. 3. FIG. 3 is a schematic view of a resistance value distribution of fan-out wires. As shown in FIG. 3, each fan-out portion in the display substrate has a number of N wires. Each wire has different numbers (1˜N) along the first direction (a). The fan-out portion has the resistance value distribution along the first direction (a). As shown in FIG. 3, the resistance value distribution of the fan-out portion forms a first curve (L1). For example, the distances between the source driver and the wires at the two sides are longer; accordingly, the fan-out wires at the two sides have larger resistance values. In contrast, the distances between the source driver and the wires at the middle position are shorter; accordingly, the fan-out wires at the middle position have smaller resistance values.

The control circuit generates a second curve (L2) according to the first curve (L1) to modulate the modulation unit in each driving circuit. In an embodiment, the control circuit identifies the relative position between the source driver and the plurality of wires to modulate the modulation unit. As shown in FIG. 3, the second curve (L2) exhibits an opposite tendency with respect to the first curve (L1). For example, the modulation units corresponding to the wires at two sides are modulated to have a lower resistance value, and the modulation unit corresponding to the wires at the middle position is modulated to have a higher resistance value.

Particularly, as shown in FIG. 3, the first curve (L1) has a first resistance value (R1) and a second resistance value (R2) which is different from the first resistance value (R1). The second curve (L2) has a first compensation value (C1) corresponding to the first resistance value (R1). In addition, the second curve (L2) has a second compensation value (C2) corresponding to the second resistance value (R2). In this embodiment, the first resistance value (R1) is larger than the second resistance value (R2).

The control unit modulates the resistance value of each modulation unit according to the resistance value of a first curve (L1). As a result, the modulation unit corresponding to the first resistance value (R1) is modulated to have the first compensation value (C1), and the modulation unit corresponding to the second resistance value (R2) is modulated to have the second compensation value (C2). As shown in FIG. 3, the second compensation value (C2) is larger than the first compensation value (C1).

The modulation result has a third curve (L3). As shown in FIG. 3, the third curve (L3) is substantially a horizontal line. In an embodiment, the third curve (L3) represents a mean value of the resistance value of the fan-out wire and the resistance value of the modulation unit. For example, a mean value of the first resistance value (R1) and the first compensate value (C1) is substantially equal to a mean value of the second resistance value (R2) and the second compensate value (C2). By the aforementioned modulation method, the resistance values of the plurality of the fan-out wires are substantially the same.

It is noted that the plurality of fan-out wires have substantially the same width by utilizing the aforementioned modulation method. Please refer to FIG. 2A, the fan-out wires 118 connected to each source driver 120 have the width. In other words, by adopting the source driver 120 of the invention, the increased size of peripheral area in the display substrate for the fan-out circuit can be eliminated. Therefore, the source driver of the invention is advantageous to the display device with narrow board design.

In other embodiments, the control circuit can modulate the modulation unit by identifying the width of the fan-out wires. For example, the fan-out wires of the fan-out portion at two sides have a thicker width while the fan-out wire of the fan-out portion at the middle position has a thinner width. In this case, the control circuit can inactivate the compensation mode (or activate the compensation mode to perform a fine-tuning for the modulation unit corresponding to the fan-out circuit at the particular position). In other words, the source driver of the invention is adapted to the display device having fan-out circuit with different widths, providing flexibility for different kinds of products.

Besides, the control circuit can change the way it modulates according to the quantity and the position of the source driver. FIG. 4 is a schematic view of another embodiment of the display device 100 of the present invention. As shown in FIG. 4, the source driver 120 and the source driver 120a are respectively disposed at the left side and right side of the display substrate 110. The two source drivers (120, 120a) are connected to the plurality of wires 102 in the display area 112 via the fan-out circuit 118.

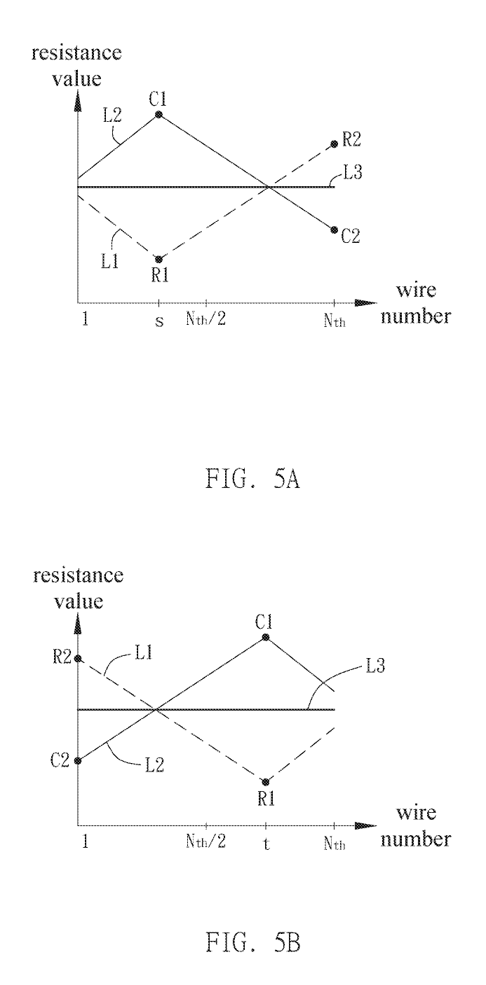

FIG. 5A and FIG. 5B are schematic views of the resistance value distribution of the fan-out wires. FIG. 5A depicts the resistance value distribution of the fan-out wires connected to the source driver 120 shown in FIG. 4. FIG. 5B depicts the resistance value distribution of the fan-out wires connected to the source driver 120a shown in FIG. 4.

As shown in FIG. 5A, the resistance value distribution of the fan-out portion forms the first curve (L1). The source driver is closer to the s^{th} wire; accordingly, the fan-out wire corresponding to the s^{th} wire has a smaller resistance value. The source driver is away from the N^{th} wire; accordingly, the fan-out wire corresponding to the N^{th} wire has a larger resistance value.

The control circuit generates the second curve (L2) according to the first curve (L1) to modulate the modulation unit in each driving circuit. As shown in FIG. 5A, the first curve (L1) has the first resistance value (R1) and the second resistance value (R2). The second curve (L2) has the first compensation value (C1) corresponding to the first resistance value (R1), and has the second compensation value (C2) corresponding to the second resistance value (R2). In this embodiment, the first resistance value (R1) is larger than the second resistance value (R2).

The control unit modulates the resistance value of each modulation unit according to the resistance value of first curve (L1). For example, for the s^{th} wire, the modulation unit corresponding to the first resistance value (R1) is modulated to have the first compensation value (C1). For the N^{th} wire, the modulation unit corresponding to the second resistance value (R2) is modulated to have the second compensation value (C2). As shown in FIG. 5A, the first compensation value (C1) is larger than the second compensation value (C2). The modulation result has the third curve (L3). As shown in FIG. 5A, the third curve (L3) is substantially a horizontal line. By the aforementioned modulation method, the resistance values of the plurality of the fan-out wires are substantially the same.

As shown in FIG. 5B, the resistance value distribution of the fan-out portion forms the first curve (L1). The source driver is away from the 1^{st} wire; accordingly, the fan-out wire corresponding to the 1^{st} wire has a larger resistance value. The source driver is closer to the t^{th} wire; accordingly, the fan-out wire corresponding to the t^{th} wire has a smaller resistance value.

The control circuit generates the second curve (L2) according to the first curve (L1) to modulate the modulation unit in each driving circuit. As shown in FIG. 5B, the first curve (L1) has the first resistance value (R1) and the second resistance value (R2). The second curve (L2) has the first compensation value (C1) corresponding to the first resistance value (R1), and has the second compensation value (C2) corresponding to the second resistance value (R2). In this embodiment, the first resistance value (R1) is smaller than the second resistance value (R2).

Similarly, the control unit modulates the resistance value of each modulation unit according to the resistance value of first curve (L1). For example, for the 1^{st} wire, the modulation unit corresponding to the second resistance value (R2) is modulated to have the second compensation value (C2). For the t^{th} wire, the modulation unit corresponding to the first resistance value (R1) is modulated to have the first compensation value (C1). As shown in FIG. 5B, the first compensation value (C1) is larger than the second compensation value (C2). The modulation result has the third curve (L3). As shown in FIG. 5B, the third curve (L3) is substantially a horizontal line. By the aforementioned modulation method, the resistance values of the plurality of the fan-out wires are substantially the same.

To sum up, in contrast to the traditional source driver, the source driver of the invention can utilize resistance value modulation inside the driving circuit to achieve the effect of resistance value compensation and prevent the size of the display area of the display substrate from being restricted.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display device, comprising:
a display substrate comprising a display area and a peripheral area surrounding the display area, at least a fan-out portion being formed on the peripheral area and distributed along a first direction, the fan-out portion having a plurality of fan-out wires; and
at least a source driver connected to one side of the fan-out portion opposite to the display area, the source driver comprising a plurality of driving circuits, an output end of each driving circuit having a modulation unit coupled to one of the plurality of the fan-out wires;
wherein the fan-out portion has a resistance value distribution along the first direction, and a resistance value of the modulation unit in each driving circuit is modulated according to the resistance value distribution.

2. The display device of claim 1, wherein the source driver further comprises a control circuit coupled to the plurality of driving circuits; the control circuit activates a compensation mode to modulate the resistance value of the modulation unit in each driving circuit according to the resistance value distribution.

3. The display device of claim 2, wherein the source driver is connected to a plurality of wires located in the display area via the plurality of fan-out wires; the control circuit judges a relative position between the source driver and the plurality of wires to modulate the modulation unit.

4. The display device of claim 1, wherein the resistance value distribution forms a first curve; the control circuit generates a second curve according to the first curve to modulate the modulation unit in each driving circuit; the second curve exhibits an opposite tendency with respect to the first curve.

5. The display device of claim 4, wherein the first curve has a first resistance value and a second resistance value different from the first resistance value; the second curve has a first compensation value corresponding to the first resistance value and has a second compensation value corresponding to the second resistance value; a mean value of the first resistance value and the first compensate value is substantially equal to a mean value of the second resistance value and the second compensate value.

6. The display device of claim 1, wherein the plurality of fan-out wires has a substantially same width.

7. The display device of claim 1, wherein the modulation unit is a metal oxide semiconductor, a diode, or a resistor.

8. The display device of claim 1, wherein the source driver generates a driving signal to be output to the display substrate via the fan-out portion; the driving signal is an analog signal or a digital signal.
